(19) United States
(12) Patent Application Publication
(10) Pub. No.: US 2005/0237424 A1
(43) Pub. Date: Oct. 27, 2005

(54) Device for mobile image communication

(75) Inventors: Johannus Wilhelmus Weekamp, Eindhoven (NL); Fransiscus Gerardus Coenradus Verweg, Heerlen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/523,280

(22) PCT Filed: Jul. 1, 2003
(86) PCT No.: PCT/IB03/03032

§ 371 Date: Feb. 2, 2005

(30) Foreign Application Priority Data
Aug. 5, 2002 (EP) 02078209.0

(51) Int. Cl. H04N 5/225

(52) U.S. Cl. 348/373

(57) ABSTRACT

The device for mobile communication comprises a first and a second camera (41, 42), which are faced towards opposite sides of the device (2A, 2C). The cameras (41, 42) each comprise an optical lens (40) and a photosensitive semiconductor device (30). The lens (40) and the semiconductor device (30) are assembled together with a carrier body (2) which is provided with an aperture (20) between the lens (40) and the semiconductor device (30). The carrier body (2) is preferably provided with a pattern of conductive tracks (1) which extends from a first side (2A) to an opposite side (2C) of the body. The two cameras may have the same carrier body (2). The device for mobile communication further comprises a display, means for switching either one of the cameras and the projection of images thereof on the display on or off, as well as means for standing the device on a surface.

The invention relates to a device for mobile communication with a first side and an opposed second side, which device is provided with a camera comprising a lens and a photosensitive element and with a picture screen on which images caught by the camera can be pictured.

Such a device is known from WO-A 01/63926. The known device is a mobile telephone with a display, which device is further provided with a unit comprising a camera and a loudspeaker. The unit is completed with a housing to which the camera and the loudspeaker are fixed with mechanical clamping connections. The unit is present in a separate compartment which is connected to the rest of the device via a vertical shaft and is rotatable about this shaft. Rotation about the shaft renders it possible to aim the camera at the first side or at the second side.

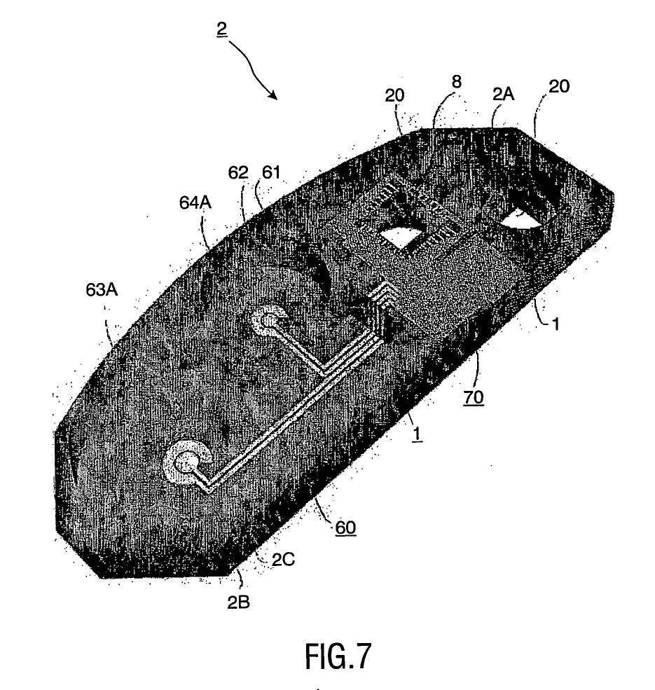

It is a disadvantage of the known device that assembling of the camera and the loudspeaker together with the housing is difficult. As FIG. 7 shows, the housing is built up from a first and a second part, which can be joined together after assembling of the camera and the loudspeaker.

It is accordingly an object of the invention to provide a device of the kind mentioned in the opening paragraph which can be manufactured more simply and which nevertheless provides the possibility of recording images both at the first side and at the second side.

This object is achieved in that
a second camera is present, comprising a lens and a photosensitive element,
the first camera is oriented towards the first side of the device, and
the second camera is oriented towards the second side of the device.

At least two cameras are present in the device according to the invention, oriented in opposite directions. The cameras are preferably fixed to a carrier body which is independent of the housing and with which at the same time electrical connections to and from the cameras are realized.

It is an advantage of the invention that the cameras need not be present in a separate unit. In this manner the shaft about which rotation takes place in the known device can be omitted. This is favorable firstly because it makes the assembly simpler. It is favorable secondly because there is no necessity for having the electrical connections of the camera to other components run through the shaft. Not only is such a shaft an expensive component—especially so in combination with a motor—, but it is also sensitive to pressure. In addition, dust and moisture may penetrate the device along the shaft.

In a preferred embodiment, the first camera and the second camera each comprise a carrier body with a first side and an opposed second side, with the lens at the first side and the photosensitive element at the second side, which carrier body has an opening which extends from the first side to the second side and is arranged between the lens and the photosensitive element.

This embodiment comprises cameras whose construction is based on a carrier body. The lens and the photosensitive element are components which are fixed to the carrier body. This carrier body gives the camera a high degree of stability and ease of handling. The carrier body may be block-shaped, or it may alternatively have a shape that matches the housings and/or other components.

The carrier body ensures the mechanical support and positioning of the camera, and at the same time the electrical contacting. This offers major advantages over the prior art. It is in fact not necessary now to fix the cameras separately to the housing, which may lead to misorientation of the camera and an imperfect connection between camera and housing. Neither is it necessary to place the cameras on a separate carrier body, which is difficult because the cameras would have to be placed at two sides of this carrier body facing away from one another.

If the carrier bodies are separate from the cameras, the two are preferably provided on one and the same portion of the housing. The carrier body may be given a suitable shape so as to ensure that the two cameras will have a stable position. It is also possible to connect the camera to the housing with glue or some other joining agent.

In a favorable embodiment, the first and the second camera have a common carrier body. In that case the lens of the first camera and the photosensitive element of the second camera are present at the first side of the carrier body. The photosensitive element of the first camera and the lens of the second camera are present at the second side. The integration of two cameras in a common carrier body saves assembly costs. In addition, the total volume can be reduced. Such a carrier body is also suitable for mounting further components, such as a loudspeaker and a display.

In a further embodiment, the picture screen is fixed to the common carrier body, and an electrical connection is present across the carrier body between the photosensitive elements of the cameras and the picture screen. The presence of the picture screen or display on the same carrier body as the cameras renders it possible to provide all electrical connections on the carrier body. The means necessary for driving and control, known per se to those skilled in the art, may then be present, for example, at the second side facing away from the picture screen. This has the advantage that a supplier of the carrier body with the cameras and the picture screen himself can test whether the entire assembly functions correctly. A further advantage is the limitation of the amount of assembling work and the number of connections to be provided between individual elements during this.

Electrical contacting of the cameras may take place, for example, by means of a substrate provided with a conductor pattern and connected to the photosensitive element. The photosensitive element may alternatively be integrated into such a substrate. Such an electrically conducting connection may be realized in the form of wire bonding or by means of metal bumps. Alternatively, the carrier body may be provided at a second side with a foil having a conductor pattern which is fixed to the carrier body, for example with glue. It is preferred, however, that the conductor pattern is integrated into the carrier body, such as is the case, for example, in a synthetic resin or ceramic substrate which comprises a plurality of internal conducting layers in accordance with a desired pattern.

It is particularly favorable if the conductor pattern is present at least substantially at the surface of the carrier body and is mechanically anchored in the carrier body. Such a carrier body is realized by starting with the conductor pattern on a temporary substrate, such that the conductors in the conductor pattern are not connected to this substrate over the entire surface. Then an insulating material is provided which fills up cavities between the substrate and overhanging conductors, while at the same time covering the conductor pattern. After removal of the temporary substrate, the carrier body with the conductor pattern at its surface is obtained. If the layer in which the conductor pattern is defined is chosen to be thin, for example between 10 and 50 μm, the conductor pattern may be provided with a resolution of the same order of magnitude.

In a further modification, the insulating material is provided by injection molding or a similar technique, for which a mold is used, and the conductor pattern extends at more than one side. The use of a mold has the advantage that the carrier body may be brought into a desired shape. If a separate module is used for the two cameras, for example, the shape may be adapted such that the carrier bodies are mutually complementary at the two sides with the semiconductor elements: projections of the one carrier body fit cavities of the other one. Furthermore, the shape of the carrier bodies is preferably adapted to the shape of the device.

The presence of the conductor pattern at more than one side is realized in that the substrate with the conductor pattern is deformed prior to the provision of the insulating material. It is favorable in particular to bend the substrate at least twice through an angle of approximately 90 degrees. This achieves that the conductor pattern extends both at the first and at the second side of the carrier body. This provides a favorable manner of electrical contacting when the cameras are present in a common carrier body.

In general, the device is provided with a lower side and an upper side, the first side extending from the lower side to the upper side. The picture screen is adjusted such that, when the lower side of the device is placed on a substrate, images are pictured in an upright position on the picture screen. It is favorable then that the first camera is present in a position between the picture screen and the upper side of the device, and that an axis of the camera defined by a center of the photosensitive element and a center of the lens encloses an angle of between 0 and 20 degrees with an axis directed perpendicularly to the picture screen, with the camera being oriented in a downward position with respect to the substrate. It is a known problem with cameras in the type of devices to which the invention relates that the camera is not present straight in front of the user, and that accordingly the picture obtained is deformed. An adaptation of the orientation of the camera to the position above the picture screen renders it possible to reduce or prevent this deformation.

The rotated position of the camera with respect to the picture screen can be very well realized by the technology described, where an already bent temporary substrate with the conductor pattern is provided in a mold. The desired angle between the surfaces can be set in the deformation process. It is also possible to press in the temporary substrate locally, so that local projections or depressions arise. The shape may be achieved by means of the mold in those portions and at those sides where no conductor pattern is present.

In a preferred embodiment, means are present in the device by which a user can switch the first and the second camera on and off. Examples of such means are a so-called touchscreen, a specific key on the keyboard for this function, and an option in a menu. Said means by which the user can switch the cameras on and off are connected to the cameras via conductors and means for electrical control. Such means are known to those skilled in the art.

In a further modification, the device is further provided with means by which a user can adjust the display of the images caught by the first and the second camera. Said means preferably are of the same type as the means for switching the cameras on and off. It may be possible here that not only the image of the first camera or the image of the second camera is shown on the picture screen, but that the two images are displayed in separate windows. Further digital image processing is also possible, for example for joining together received images, mounting them to a short film, or processing them into a digital file of reduced size. Such a size reduction is relevant for the transmission of the file over a wireless telecommunication link.

In an equally favorable embodiment, the first camera is provided with a lens which is optimized for receiving images from a distance of at most one meter to the lens, and the second camera is provided with a lens which is optimized for receiving images from a distance of at least one meter to the lens. The use of two cameras aimed in different directions renders it possible for each camera to be chosen to suit the distances and objects at which they are aimed. Besides the optimization of the lens, the photosensitive elements may be chosen to be different, so that the resolution of the first camera differs from the resolution of the second camera. Other aspects that may be weighed in the choice of lens and photosensitive element are inter alia the amount of movement of the object per unit time; the desired color and color correction; and the possibility of adapting the camera orientation manually or with a motor.

In a further embodiment, means are present by which the device can be placed on a substrate such that at least one of the cameras can record an image desired by a user without the user having to hold the device. If a user wishes to catch a certain image during some time, it is advantageous that the or she can place the device on a substrate. An example that springs to mind is the use of the device as a digital camera, or the use of a mobile telephone during video conferencing. The device, and in particular a mobile telephone, however, does not have a shape such that the device remains in a position in which the camera records the desired image. Indeed, an upright position of the mobile telephone or a slightly forward or backward inclined position will be desired for a mobile telephone. The embodiment provides means for this purpose, i.e. for positioning the device.

A first embodiment of the means for positioning is a U-shaped stand with two legs and a connecting bar, which stand is rotatable about an axis through the two legs and substantially parallel to the connecting bar. The connecting bar may be provided with a flat surface for a stable placement, which surface can be rotated with respect to the legs. To set the angle of the device with respect to the substrate more precisely, it is favorable if the position where the legs are mechanically joined to the device can be shifted along the device.

A second embodiment of the means comprises a holder with a base surface and a raised rail at a first and a second side. A complementary part, or one or several projections at the device corresponding with the rail, ensures that the device can be fixed in the rail. Positions may be defined by means of widened and narrowed portions in the rail.

A third embodiment of the means comprises one or several substantially rod-shaped carriers of suitable length which can be fixed to the device in a number of positions. These carriers essentially form additional legs.

These and other aspects of the device according to the invention will be explained in more detail with reference to diagrammatic Figures, in which:

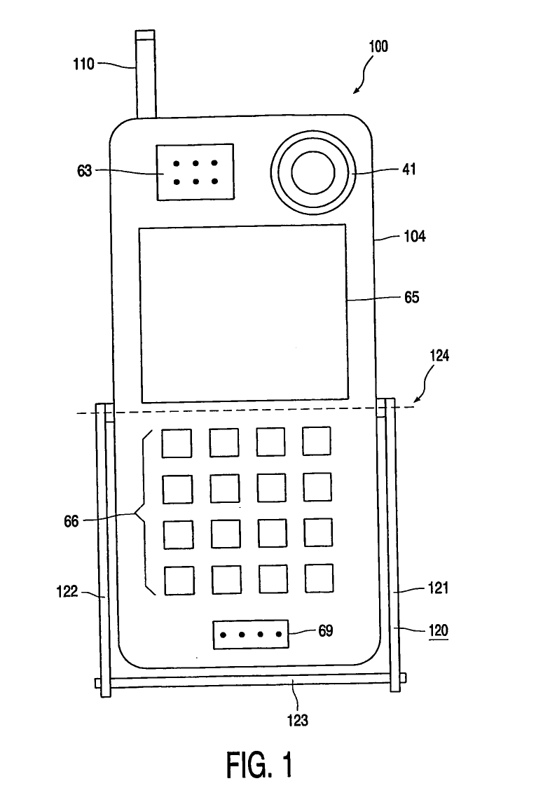

FIG. 1 shows a first side of the device;

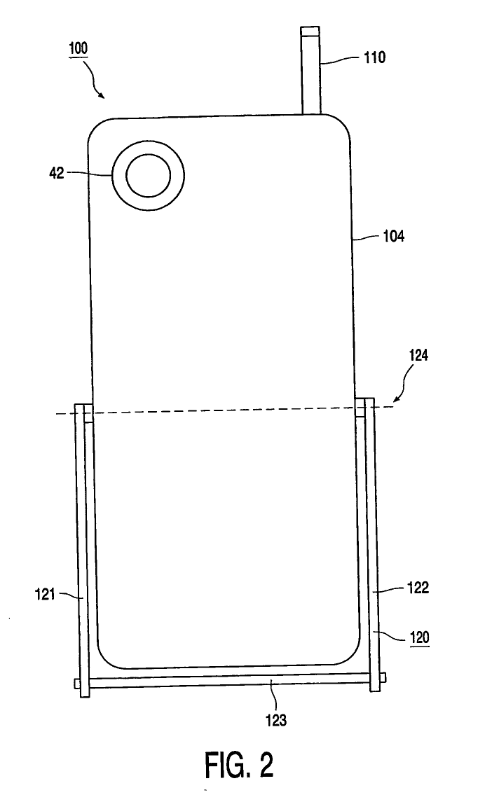

FIG. 2 shows a second side of the device facing away from the first side;

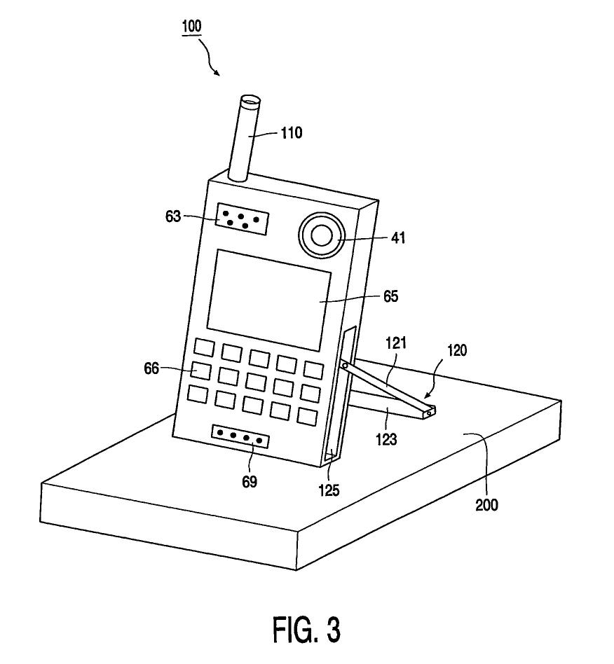

FIG. 3 is a perspective view of the device provided with means for positioning the device;

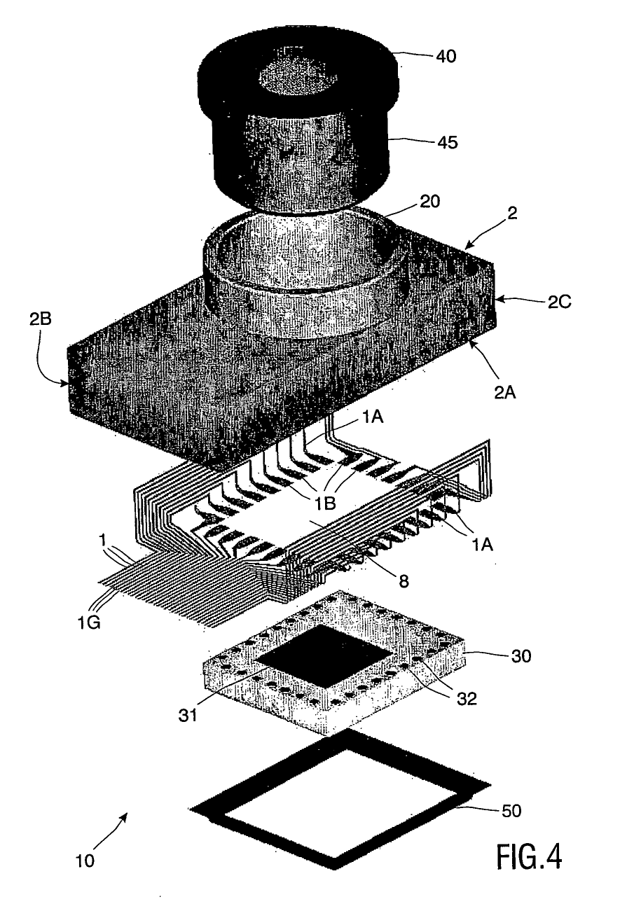

FIG. 4 is a perspective exploded view of a compact camera suitable for use in the device;

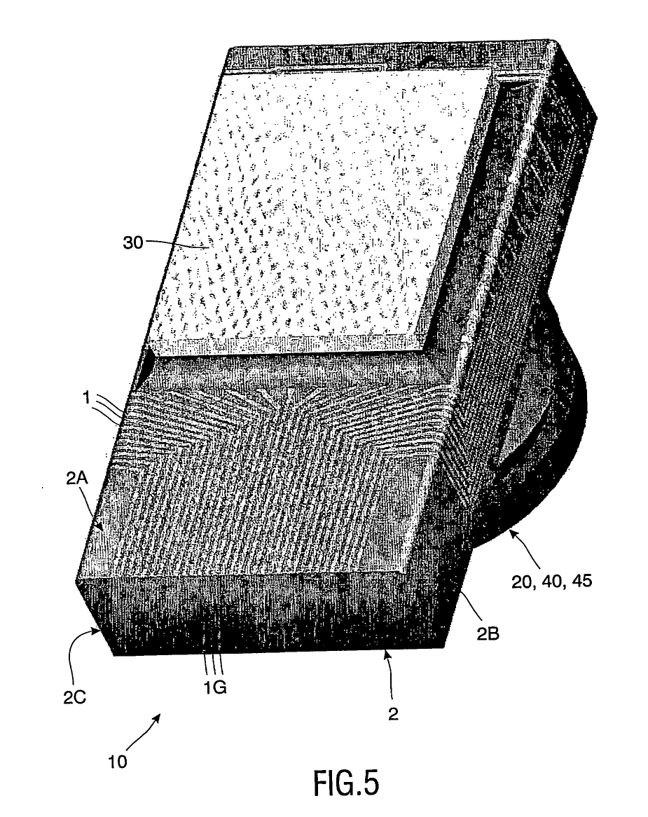

FIG. 5 is a perspective view of the camera in an assembled state, at an angle of 180° with respect to the view of FIG. 4;

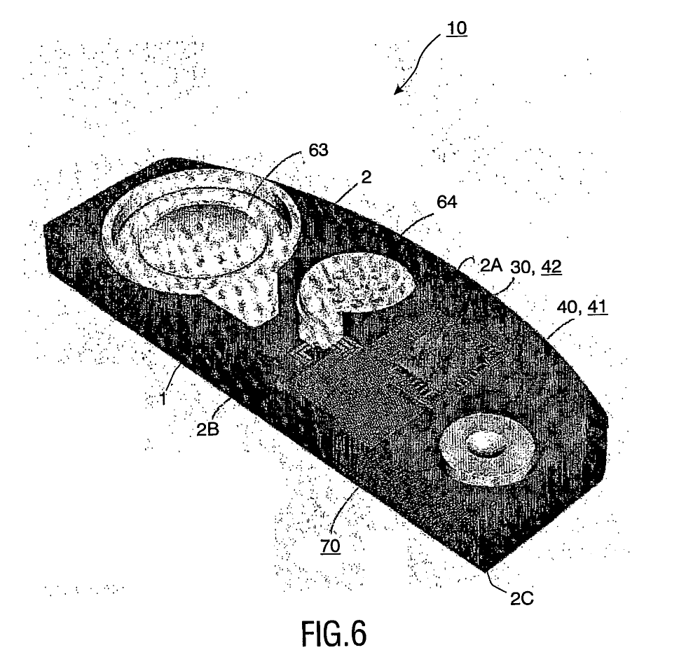

FIG. 6 shows two cameras assembled on a common carrier body;

FIG. 7 shows the carrier body of FIG. 6;

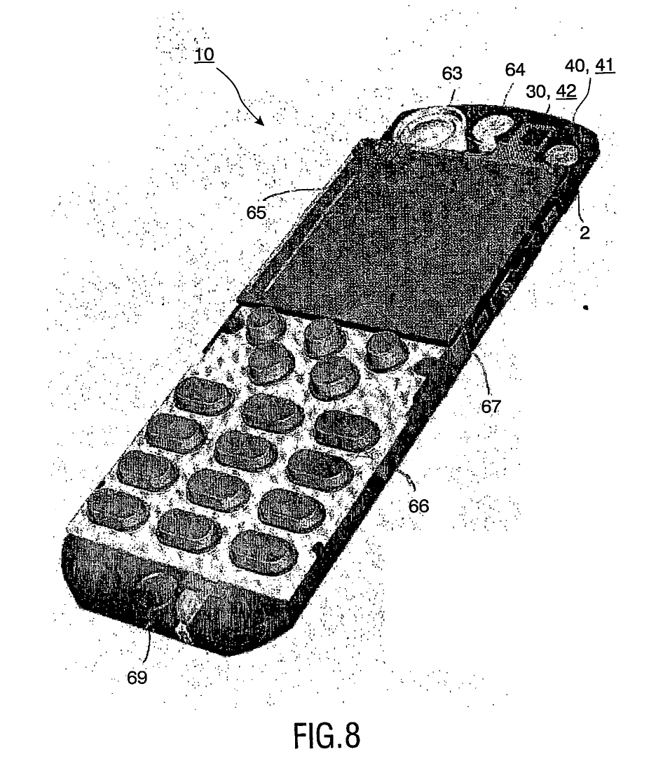

FIG. 8 shows an embodiment which is an alternative to FIG. 6, many more components being present on the carrier body; and

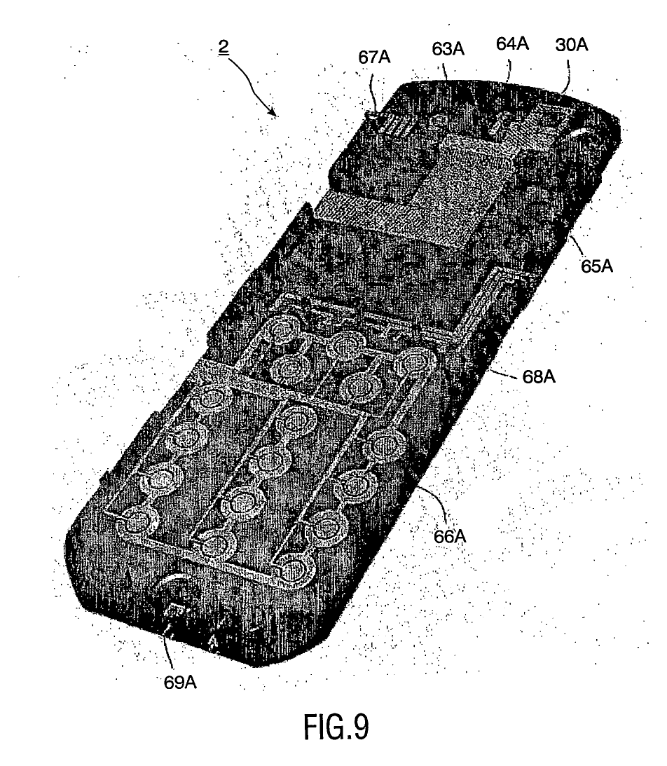

FIG. 9 shows the carrier body of FIG. 8.

The Figures are not drawn to scale, and identical components have been given the same reference numerals in the various Figures.

FIG. 1 diagrammatically shows the front of a device for mobile communication 100.

FIG. 2 diagrammatically shows the rear of the device 100. The device 100 is an example of a hand-held device, but the invention may find a wider application in other such devices, such as a PDA, a palm top or portable computer, and also a DECT telephone, where a portable device is wirelessly connected to an exchange connected to a wired telephone network. The device 100 is provided with a first camera 41, a second camera 42, a housing 104, a picture screen 65, a set of keys 66, an antenna 110, a loudspeaker 63, and a microphone 69. The device is furthermore provided with means 120 for placing the mobile telephone on a base surface in a stable manner. Said means in this example are U-shaped with legs 121, 122 and a connecting bar 123, such that the legs can rotate about an axis 124. The connecting bar 123 can also rotate with respect to the legs 121, 122. A user can switch the first and the second camera 41, 42 on and off by means of the keys 66 or by touching the screen 65—this then being a touchscreen mechanism—, with or without projection on the picture screen 65. Preferably, a separate key 66 is present for these functions or for a number thereof, so that the user can adapt the cameras 41, 42 and the display of recorded images on the picture screen 65 in a very simple manner.

FIG. 3 shows the device 100 in perspective view, with a slightly different set of keys 66 being provided. This Figure shows how the device can be positioned on a base surface 200. The legs 121, 122 are rotated and shifted along the rail 125 for this purpose. The connecting bar 123 rotates slightly during this, so that it rests flat on the base surface 200. The device 100 is securely placed in that positions are defined in the rail, in particular by means of widened or deepened portions. The device may be aimed at an object to be observed by the camera 41 in this manner, for example a user's face during a telephone conference. Alternatively, the positioning means 120 may be collapsed towards the front of the device, so that a position is obtained in which the second camera 42 (not shown here) is oriented slightly upwards with respect to the base surface 200.

FIG. 4 is a diagrammatic, perspective, exploded view of an electronic device according to the invention comprising a compact camera. FIG. 5 diagrammatically shows this device in perspective view and in the assembled state at an angle of 180 degrees with respect to FIG. 4. The device 10—see, for example, FIG. 1—comprises a synthetic resin carrier body 2, made of PPS (=PolyPhenylene Sulphide) here, in which an opening 20 is present in which an optical lens 40 arranged in a cylindrical holder 45 is fastened. At the other side of the opening 20, a rectangular closed shape 8 of connection regions 1B present at respective ends 1A of strip-shaped conductors 1 is present on a flat surface 2A of the carrier body 2. The conductors 1 extend directly to the end of the surface 2A at one side of the closed shape 8, where accordingly the other ends 1C of the strip-shaped conductors 1 are present. The strip-shaped conductors 1 present at the other three sides of the closed shape 8 run partly over the surface 2A, but for the rest partly over two side faces 2B, 2C of the body 2 which are perpendicular to the surface 2A. The conductors 1 present at the rear of the closed shape 8 then distribute themselves over the two side faces 2B, 2C. The device 10 in this example can be particularly compact as a result of this. In addition, its manufacture is simple and inexpensive.

Furthermore, a photosensitive semiconductor element 30, a so-called CCD (=Charge Coupled Device) or CMOS (=Complementary Metal Oxide Semiconductor) sensor 30, is fastened against the surface 2A of the carrier body 2 by means of a frame 50. The photosensitive region 31A of the sensor 30 is then present opposite the opening 20 in the body 2, and the connection regions 32 of the sensor 30 are fastened with electrical conduction to connection regions 1B of the strip-shaped conductors 1 lying in the closed shape 8.

FIG. 5 shows the device 10 once more from a different side, in the assembled state this time. The signals from the device 10 may be taken off and/or passed on at the ends 1C of the conductors 1, for example within a mobile telephone (not shown) for which the device 10 is particularly suitable because of its compactness in three directions. This compactness in addition renders it possible for two cameras to be placed in one mobile telephone. To simplify the connection, the conductors 1 may extend to another side of the device 10 facing away from the first side 2A and may have a contacting region at this other side. The connections of the two cameras will be at the same side when one camera having this contacting region at the first side 2A and one camera having a contacting region at the side facing away therefrom are used in a mobile telephone.

FIG. 6 shows a device 10 which comprises two cameras on one common carrier body 2 and which is suitable for incorporation in an apparatus for mobile communication.

FIG. 7 shows the corresponding carrier body 2. The carrier body shown is manufactured from a foil having a first layer of a first material and a second layer of an electrically conducting material different from the first material. The second layer is patterned in accordance with a desired pattern. The foil in this example comprises a first layer of aluminum and a second layer of copper. After the foil has been deformed by bending and, if so desired, impressing, the insulating material is provided in a mold. The contours of the body are defined by the shape of the mold, including openings 20 through the body and cavities 60 for the mounting of components. Then the first layer is removed from the foil by etching, polishing, a combination of the two, or by mechanical means. The conductor pattern thus comes to lie at the surface of the carrier body 2. Depending on the specific embodiment, the conductor pattern will then lie flush with the surface, slightly below it, or slightly above it. The carrier body 2 may be manufactured according to the method described in EP02076427.0 (PHNL020319).

This procedure yields not only openings 20, but also a cavity 60 with a side wall 61 and a bottom 62, the conductor pattern extending up to the bottom 62. The cavity 60 is suitable for accommodating elements such as a loudspeaker 63 and a buzzer 64, as shown in FIG. 6. The device 10 is further provided with two lenses 40 and two photosensitive semiconductor elements 30 which are aligned to mutually remote sides 2A, 2C of the device 2. One lens 40 and one photosensitive semiconductor element 30 then form the camera 41 together with the interposed electrically insulating body. To realize this, the conductor pattern extends from the first side 2A via the second side 2B to the third side 2C.

Two cameras are present in this embodiment, but it is possible in principle for more cameras to be present. Furthermore, the axes of the cameras are defined as lines through the centers of the lens 40 and the photosensitive semiconductor element 30 and are thus substantially parallel. It is possible, however, to modify the orientation of one or both cameras 41 as desired through adaptation of the angle through which the foil is bent and a corresponding adaptation of the mold for providing the insulating material. Electrical contacting to the outer world is necessary for controlling all electrical elements in a suitable manner. This contacting is realized with a flexible foil (not shown) which is connected to a contacting region 70 on which ends 71 of conductors 1 are present in a substantially parallel arrangement. It is noted that the conductors 1 come from various elements 30, 63, 64. The conductors preferably have a width of the order of 10 to 50 μm and are preferably spaced apart by between 40 and 80 μm. It is further noted that the conductor tracks may have different widths outside the contacting region 70; in the embodiment the conductors 1 to the buzzer and the loudspeaker have a width of approximately 200 μm, each such track ending in three conductors 1 in the contacting region 70.

FIG. 8 shows an alternative embodiment of the device 10, and FIG. 9 shows the corresponding electrically insulating carrier body 2. The body in this example is the carrier for a large number of desired electronic elements of a mobile telephone. These are in particular the elements which provide the interface to the user. At the rear side 2C (not shown) of the body 2, conductors 1 provide interconnections between the elements, and connection regions are present for the placement of elements which implement the required control functions. It is also possible for a contacting region for a flexible foil or a connector to be defined at that side. Connections are present for a semiconductor element of a camera 41, a loudspeaker 63, a buzzer 64, a display 65, keys 66, a touchscreen 67, lamps 68 (preferably light-emitting diodes), and a microphone 69, FIG. 9 showing the connections of the elements by their reference numerals followed by A (for example 30A). It is noted that the body has the advantage that a direct connection between the cameras 41 and the picture screen 65 and the keys 66 and/or the touchscreen 67 is also possible without connections having to be realized by means of connectors or flexible foils. The number of connections may thus be advantageously reduced, and the camera 41 and picture screen 65 can be mutually attuned in the assembly.

1. A device for mobile communication with a first side and an opposed second side, which device is provided with a camera comprising a lens and a photosensitive element and with a picture screen on which images caught by the camera can be pictured, characterized in that a second camera is present, comprising a lens and a photosensitive element,
the first camera is oriented towards the first side of the device, and
the second camera is oriented towards the second side of the device.

2. A device as claimed in claim 1, characterized in that the first camera and the second camera each comprise a carrier body with a first side and an opposed second side, with the lens at the first side and the photosensitive element at the second side, which carrier body has an opening which extends from the first side to the second side and is arranged between the lens and the photosensitive element.

3. A device as claimed in claim 2, characterized in that the first and the second camera have a common carrier body such that the lens of the first camera and the photosensitive element of the second camera are present at the first side of the carrier body, while the photosensitive element of the first camera and the lens of the second camera are present at the second side.

4. A device as claimed in claim 3, characterized in that the picture screen is fixed to the common carrier body, and an electrical connection is present across the carrier body between the photosensitive elements of the cameras and the picture screen.

5. A device as claimed in claim 2, characterized in that the carrier body is electrically insulating with a conductor pattern at a surface, which conductor pattern extends at several sides of the carrier body and is mechanically anchored in the carrier body.

6. A device as claimed in claim 1, characterized in that
the device is provided with a lower side and an upper side, the first side extending from the lower side to the upper side,
the picture screen is adjusted such that, when the lower side of the device is placed on a substrate, images are pictured in an upright position on the picture screen,
the first camera is present in a position between the picture screen and the upper side of the device, and
an axis of the camera defined by a center of the photosensitive element and a center of the lens encloses an angle of between 0 and 20° with an axis directed perpendicularly to the picture screen, with the camera being oriented in a downward position with respect to the substrate.

7. A device as claimed in claim 1, characterized in that means are present in the device by which a user can switch the first and the second camera on and off.

8. A device as claimed in claim 1, characterized in that the device is further provided with means by which a user can adjust the display on the picture screen of the images caught by the first and the second camera.

9. A device as claimed in claim 1, characterized in that
the first camera is provided with a lens which is optimized for receiving images from a distance of at most one meter to the lens, and
the second camera is provided with a lens which is optimized for receiving images from a distance of at least one meter to the lens.

10. A device as claimed in claim 1, characterized in that means are present by which the device can be placed on a substrate such that at least one of the cameras can record an image desired by a user without the user having to hold the device.
